(19) United States
(12) Patent Application Publication
(10) Pub. No.: US 2002/0114307 A1
(43) Pub. Date: Aug. 22, 2002

(54) Method and configuration for wireless information transmission and information system for a machine exhibiting a multiplicity of sensors and/or actuators

(76) Inventors: Christoffer Apneseth, Oslo (NO); Snorre Kjesbu, Siependen (NO); Harald Vefling, Borgheim (NO)

Correspondence Address: LERNER AND GREENBERG, P.A., Post Office Box 2480, Hollywood, FL, 33022-2480, US

(21) Appl. No.: 10/054,442

(22) Filed: Jan. 22, 2002

Related U.S. Application Data
(63) Continuation of application No. PCT/EP00/06217, filed on Jul. 4, 2000.

(30) Foreign Application Priority Data
Jul. 20, 1999 (DE) 199 33 814.0

(51) Int. Cl. H04B 7/216; H04J 3/06

(52) U.S. Cl. 370/342; 370/516

(57) ABSTRACT

A method and a device for wireless information transmission between a base station radiating a broadband radio-frequency signal preferably generated in accordance with the Direct Sequence Spread Spectrum (DSSS) method and a multiplicity of subscribers are described. The subscribers are located at different distances from the base station. The subscribers code the received radio-frequency signal in accordance with the code division multiple access (CDMA) method according to the information to be transmitted, modulate it and reflect it back to the base station. The base station effecting a signal correlation and demodulation, and the base station automatically compensates for different propagation losses between the subscribers located at different distances from the base station in that the correlation function, on the one hand, and the propagation loss, on the other hand, are linked to one another in an inverse relationship.

### CROSS-REFERENCE TO RELATED APPLICATION

This application is a continuation of copending International Application PCT/EP00/06217, filed Jul. 4, 2000, which designated the United States.

### BACKGROUND OF THE INVENTION

1. Field of the Invention

The invention relates to a method for wireless information transmission between a base station radiating a broadband radio-frequency signal preferably generated in accordance with a direct sequence spread spectrum (DSSS) method and a multiplicity of subscribers or stations. The subscribers are located at different distances from the base station, the subscribers coding the received broadband radio-frequency signal in accordance with the code division multiple access (CDMA) method according to the information to be transmitted, modulating it and reflecting it back to the base station. The base station effecting a signal correlation and demodulation of the received response signals.

The invention can be used, in particular, for wireless information transmission by radio frequency signals with an industrial robot, an automatic manufacturing machine or automatic production machine that exhibits a multiplicity of proximity sensors/proximity switches and/or actuators. The invention provides for wireless information transmission between a base station with a connected process computer and a multiplicity of subscribers, in this case proximity sensors/proximity switches and/or actuators. The subscribers used can also be, for example, temperature measuring sensors, pressure measuring sensors, current measuring sensors or voltage measuring sensors, micromechanical, piezoelectrical, electrochemical, magnetostrictive, electrostrictive, electrostatic or electromagnetic actuators or indicating elements.

The wireless communication between a base station and a number of subscribers usually takes place via a radio-frequency carrier. It is particularly advantageous in this context if, for the purpose of transmitting information, the subscribers modulate the received radio-frequency carriers and reflect them back to the base station because the subscribers do not need to generate their own radio-frequency signals for information transmission in such a case but use the radio-frequency signal of the base station (backscatter system).

In distinction from the demodulation of an externally generated radio-frequency signal produced in the subscriber itself, the demodulation of the modulated radio-frequency signal is not critical for the base station, for example with regard to the phasing. In comparison with the external generation of the radio-frequency signal in the subscriber, the reflection of the radio-frequency signal is also much more advantageous with regard to the required energy consumption. Overall, a considerable cost reduction is obtained, both with regard to the production costs and with regard to the running operating costs.

From Published, European Patent Application EP 09 15 573 A, for example, such a modulated backscatter system is known in which a broadband radio-frequency signal generated in accordance with the Direct Sequence Spread Spectrum method is radiated from a base station to a multiplicity of subscribers or stations. The subscribers reflect the received signal that is modulated in accordance with information to be transmitted back to the base station.

The use of the multiple access method CDMA (see, for example, the literature references below in this regard) is also generally known. When CDMA is used, however, it is of importance that the power of the signals reflected by the subscribers is approximately of equal magnitude since otherwise interfering and inadmissible interferences occur due to the subscribers transmitting simultaneously. Usually, a power control system is therefore provided in order to even out the powers of the signals received by the base station. However, such a power control system is expensive and requires a two-way exchange of information between the base station and the subscribers.

### SUMMARY OF THE INVENTION

It is accordingly an object of the invention to provide a method and a configuration for wireless information transmission and an information system for a machine exhibiting a multiplicity of sensors and/or actuators which overcome the above-mentioned disadvantages of the prior art devices and methods of this general type, in which interferences between the subscribers are minimized.

With the foregoing and other objects in view there is provided, in accordance with the invention, a method for a wireless information transmission. The method includes radiating a broadband radio-frequency signal between a base station and a multiplicity of subscribers. The subscribers are located at different distances from the base station. The broadband radio-frequency signal received in the subscribers is coded in accordance with a code division multiple access method according to information to be transmitted resulting in a coded broadband radio-frequency signal. The coded broadband radio-frequency signal is modulated resulting in a modulated broadband radio-frequency signal. The modulated broadband radio-frequency signal is reflected back to the base station resulting in response signals received in the base station. A signal correlation and demodulation of the response signals received in the base station are performed. During the signal correlation, a time offset of a correlation peak is achieved and a time of the time offset of the correlation peak is calculated in such a manner that the response signals received from the subscribers disposed at a shorter distance to the base station are more attenuated than the response signals of the subscribers disposed at a greater distance from the base station, resulting in automatic compensation for different propagation losses between the subscribers located at the different distances from the base station.

According to the invention, the object is achieved in that during the correlation, a time offset of the correlation peak is achieved and the time of the offset of the correlation peak is calculated in such a manner that the response signals of the short-range subscribers are more attenuated than the signals of the more distant subscribers, which automatically compensates for different propagation losses between subscribers located at different distances from the base station.

The advantages that can be achieved by the invention consist in that no power control system for controlling transmitting powers is required, which has considerable cost advantages. No two-way information exchange between the base station and the subscribers is required, an information transmission from the subscribers to the base station is sufficient. There is automatic compensation for the propagation loss associated with each subscriber in the sense of evening out the propagation losses of all subscribers.

A wireless communication system is made possible which has a very high subscriber density, with high information transmission density, with high reliability with regard to the data transmission without interfering interferences, with high data integrity and with a short data latency time. The individual subscribers have low complexity, low losses and low power consumption and can be produced inexpensively. Overall, there is a high degree of capability for suppressing interference and frequency-selective fading is reduced in a significant way.

The invention is of great advantage in particular in the case of a network consisting of at least one base station and a multiplicity of subscribers because it allows for high subscriber density and high signal density and ensures high accuracy and high reliability during the data transmission.

In accordance with an added mode of the invention, there is the step of adapting a chipping rate of the broadband radio-frequency signal emitted by the base station to the different distances between the subscribers and the base station.

In accordance with another mode of the invention, there is the step of generating the broadband radio-frequency signal in accordance with a direct sequence spread spectrum method.

In accordance with a further mode of the invention, there is the step of adapting a chipping rate of the broadband radio-frequency signal emitted by the base station to the propagation loses between the subscribers and the base station.

With the foregoing and other objects in view there is provided, in accordance with the invention, a configuration for a wireless information transmission. The configuration contains a base station radiating a broadband radio-frequency signal and has a transmitting device, a modulator/coder connected to the transmitting device, a receiving device and a demodulator/decoder with a correlator connected to the receiving device. A multiplicity of subscribers are located at different distances from the base station. Each of the subscribers has a modulation device and an antenna/backscattering device for receiving the broadband radio-frequency signal and for reflecting a response signal, coded in accordance with a code division multiple access method and modulated by the modulation device in accordance with information to be transmitted. The modulation device is connected to the antenna/backscattering device. The correlator of the base station performs automatic compensation for different propagation losses between the subscribers located at different distances from the base station by linking a correlation function and a propagation loss to one another in an inverse relationship.

In accordance with an added feature of the invention, the base station generates the broadband radio-frequency signal in accordance with a direct sequence spread spectrum method.

With the foregoing and other objects in view there is provided, in accordance with the invention an information system for a machine having a multiplicity of sensors and/or a multiplicity of actuators. The information system contains a base station radiating a broadband radio-frequency signal and has a transmitting device, a modulator/coder connected to the transmitting device, a receiving device and a demodulator/decoder with a correlator connected to the receiving device. A multiplicity of subscribers are located at different distances from the base station. Each of the subscribers has a modulation device and an antenna/backscattering device for receiving the broadband radio-frequency signal and for reflecting a response signal, coded in accordance with a code division multiple access method and modulated by the modulation device in accordance with information to be transmitted. The modulation device is connected to the antenna/backscattering device. The correlator of the base station performs automatic compensation for different propagation losses between the subscribers located at different distances from the base station by linking a correlation function and a propagation loss to one another in an inverse relationship.

In accordance with an additional feature of the invention, the sensors are proximity sensors.

In accordance with a further feature of the invention, the base station generates the broadband radio-frequency signal in accordance with a direct sequence spread spectrum method.

In accordance with a concomitant feature of the invention, the machine is an automatic production machine.

Other features which are considered as characteristic for the invention are set forth in the appended claims.

Although the invention is illustrated and described herein as embodied in a method and a configuration for wireless information transmission and an information system for a machine exhibiting a multiplicity of sensors and/or actuators, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is an illustration of a configuration for wireless information transmission between a base station and a multiplicity of subscribers according to the invention;

FIG. 2 is a block diagram of sensor as an example of a subscriber with an associated base station; and

FIGS. 3 and 4 are two loss/time diagrams for explaining a method according to the invention (not true to scale).

### DESCRIPTION OF THE PREFERRED EMBODIMENTS

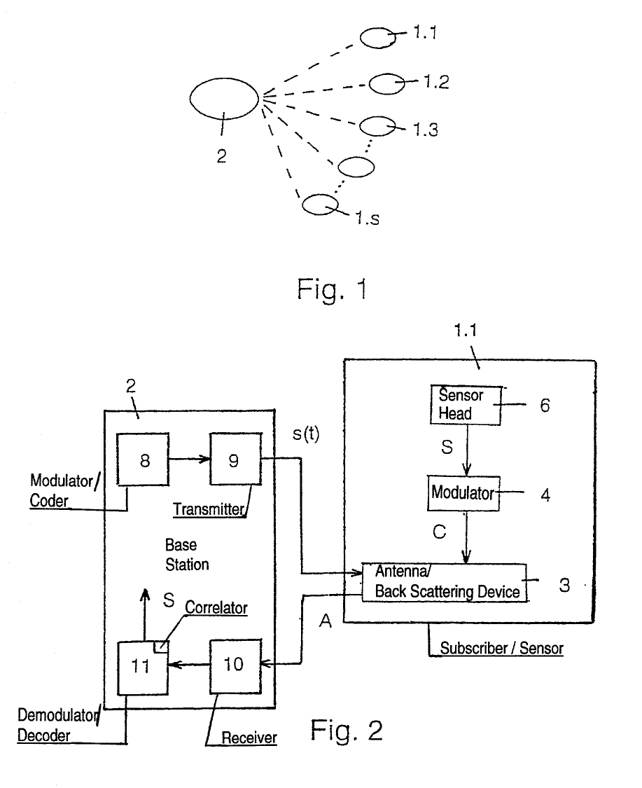

In all the figures of the drawing, sub-features and integral parts that correspond to one another bear the same reference symbol in each case. Referring now to the figures of the drawing in detail and first, particularly, to FIG. 1 thereof, there is shown a configuration for wireless information transmission between a base station 2 and a multiplicity of stations or subscribers 1.1, 1.2, 1.3 . . . 1.s, preferably sensors or actuators (backscatter system). Communication between the base station and the subscribers 1.1 to 1.s is preferably in accordance with the direct sequence spread spectrum (DSSS) method, i.e. the base station 2 sends a broadband radio-frequency signal to the subscribers 1.1 to 1.s.

Where “radio-frequency signals” have been mentioned above, this also includes very high frequency signals, extremely high frequency signals, ultrahigh frequency signals and superhigh frequency signals, of course.

With respect to the spread spectrum transmission technique, reference is made to the textbook titled “Digitale Kommunikation über Funk: Methoden und Meβtechnik digitaler Nachrichtenübermittlung” [Digital Communication By Radio: Methods and Measuring Technology Of Digital Information Transmission] by P. Hatzold, Franzis Verlag, 1999, page 171 to 182. Spread spectrum signals cause the emissions to have a wide bandwidth. An eminent characteristic of these signals is that the radio-frequency bandwidths used for their transmission is much greater than the symbol rate of the data signal. This leads to the transmitting power being distributed over a wide frequency range, and thus to an extremely low spectral power density. As a result, it is difficult to detect the signals in the noise. The capacity, i.e. the amount of information that can be transmitted, increases linearly with the bandwidth. Another characteristic of these signals is their great similarity to white noise that comes from the baseband signals being linked to pseudo random sequences.

In principle, the bandwidth can be spread in two ways. Either the carrier frequency is changed in accordance with a pseudo random sequence during the period of transmission of a symbol (fast frequency hopping), or the symbols to be transmitted are combined with a Pseudo Random Bit Sequence (PRBS, spreading code) of much higher clock rate (DSSS) before they modulate the radio-frequency carrier. Naturally, the pseudo random sequence used in each case must be known to the subscribers in both cases so that they can correct the received frequency to the random sequence of the transmitter in the case of fast frequency hopping or filter the signal intended for them from the noise spectrum by correlation techniques in the case of DS Spread Spectrum. The individual subscribers 1.1 to 1.s of the network respond to the base station 2 and reflect response signals A, provided with corresponding information (for example detected sensor information) and coded in accordance with the code division multiple access (CDMA) method and modulated, back to the base station 2.

With respect to the CDMA method, general reference is made to the technical compendium titled “Informationstechnologie von A-Z”, Aktuelles Nachschlagewerk für die berufliche Praxis [Information Technology From A-Z, Up-To-Date Work Of Reference For Professional Practice], volume 1, Interest GmbH, Augsburg, February 1999. This multiple access method is based on the code division multiplex (CDM) method and enables all users of a network to respond at the same frequency. Identification of and distinguishing between the individual users 1.1 to 1.s takes place due to the fact that the backscattered signals are combined with an individual pseudo random code for each subscriber. The response signals of all users, which are equipped with different codes, are superimposed on one another and result in a broadband spread spectrum that is wider than the original signal by the code-dependent spreading factor.

The spreading factor is a measure of how many signals can be added together.

The pseudo random sequence (spreading code) is specified separately in the sense of a code division (allocation of a local address) for each subscriber 1.1 to 1.s and is known to the base station.

FIG. 2 shows a sensor, particularly a proximity sensor, as an example of the station or subscriber 1.1 with the associated base station 2. The sensor 1.1 exhibits an antenna/backscattering device 3, a modulation device/coding device 4 and a sensor head 6. Other units of the sensor 1.1 that are not of interest here, for example a power unit suitable for supplying power, are not shown. Apart from the units that are not of interest here, the base station 2 exhibits a modulator/coder 8, a transmitting device 9, a receiving device 10 and a demodulator/decoder 11.

The sensor 1.1 receives the broadband radio-frequency signal s(t) radiated by the base station 2. The sensor head 6 supplies detected sensor information S to the modulation device/coding device 4, which generates corresponding modulation signals C and supplies them to the antenna/backscattering device 3. From response signals A received via the radio link antenna/backscattering device 3—the receiving device 10, the demodulator/decoder 11 (including a correlator 15) of the base station 2 forms the sensor information S transmitted by the individual subscriber, in this case the sensor 1.1.

At the same time, the base station 2 receives all other signals of the other subscribers as aggregate noise power. The aggregate noise power can be much greater than the received power of the signal to be received. The individual signal only apparently drowns in the noise of the aggregate noise power.

In a cellular system having a number of subnetworks (cells), where each subnetwork exhibits a base station and a number of subscribers, communication between base stations and associated subscribers also takes place, for example, in the CDMA method, a different code sequence being allocated to each subnetwork.

As an alternative, communication between base stations and associated subscribers in a cellular system can also take place, for example, in the frequency division multiple access (FDMA) method, a different frequency being allocated to each subnetwork.

The essential concept of the invention is automatic compensation for different propagation losses between subscribers or stations 1.1 to 1.n that are located at different distances from the base station 2. The starting point is the consideration that the above-mentioned communication method with CDMA and correlation is advantageous in the sense that the base station no longer needs to be synchronized to the response signals of the subscribers since there is already a phasing which is perfect apart from the propagation time of the signals. The time required by the signal returning to the base station 2 depends on the distance between the base station and the individual subscribers, i.e. there is a direct connection between the arrival time of the signal and the distance, and thus the propagation loss, since the latter depends approximately on the distance. The closer the subscriber is located to the base station, the stronger the received signal and the earlier it will arrive.

The invention produces restrictions with respect to the signal transmission rate and the time offset which can be achieved by the correlation—called offset of the correlation peak in the text that follows, so that the correlation function, on the one hand, and the propagation loss, on the other hand, can be linked to one another in an inverse relationship. If the propagation loss in the area of interest is inversely matched to the offset of the correlation peak, it will produce a flat amplitude response, (i.e. more attenuated) after the correlator even in the short range. If it is desired to maintain the good signal/noise ratio in the short range, this can be made possible by another correlator.

From the prior art, synchronization curves in the form of S curves, which can be generated by offsets of correlation peaks which can be adapted in many ways (inversely) to loss curves, are known in conjunction with code synchronization loops. Furthermore, offsets of correlation peaks can be generated which reduce the received energy of the subscribers in the short range by combining different correlation functions (with different offsets) and/or using altered reference functions (for example with a three-step sequence). In this connection, it is appropriate to divide the subscribers 1.1 to 1.s into different zones in dependence on their distance from the base station 2 in order to use in this manner different measures for the individual zones which reduce the interferences occurring in the communication between the subscribers 1.1 to 1.s and the base station 2.

In particular, the DSSS chipping rate of the signal radiated by the base station is adapted to the propagation loss curve that, in turn, depends on the frequency and the range of distances of interest. The chipping rate is defined as 1/T_{c} where T_{c} is the chip period and corresponds to the reciprocal of the PRBS clock rate.

The time of the offset of the correlation peak can be calculated adaptively in dependence on the configuration actually present, containing at least one base station 2 and a multiplicity of the subscribers 1.1 to 1.s and an algorithm running automatically can optimize this either continuously or at fixed time intervals or once on installation of the configuration.

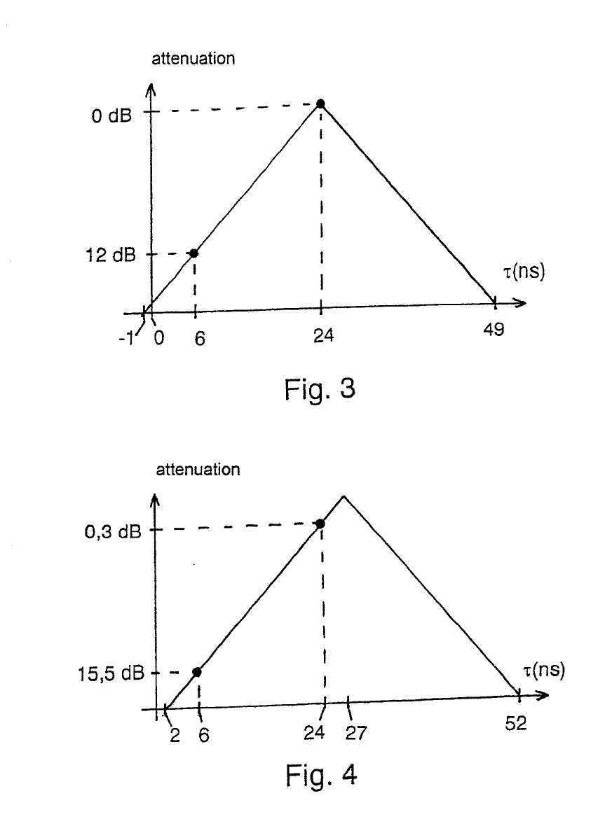

The invention will be explained in greater detail with an actual example and referring to the loss/time diagrams according to FIGS. 3 and 4. A configuration is given which contains the base station 2 and the multiplicity of subscribers 1.1 to 1.s within a range of 1 to 4 m distance, communication between the base station and the subscribers taking place by use of DSSS at a carrier frequency of 2.4 GHz and a chipping rate of 40 MHz (25 ns period). The close-range signal path (1 m distance) is 2 m so that the first signal returns after t₁=6 ns attenuated by 60 dB (referred to the transmit level, Rayleigh factor 1.5). The long-range signal path (4 m distance) is 8 m so that the second signal returns after t₂=24 ns attenuated by 78 dB (referred to the transmit level). The difference between the two propagation losses is disadvantageously relatively high at 18 dB, which leads to interfering interferences.

Placing the correlation peak on t₂=24 ns—as shown in FIG. 3—has the result that the first signal is additionally attenuated by a further 12 dB whereas the propagation loss of the second signal remains unchanged, i.e. a loss of 78 dB in the second signal is now contrasted with a loss of 72 dB in the first signal. The difference between the two propagation losses has now been reduced to 6 dB.

Placing the correlation peak on t₃=27 ns—as shown in FIG. 4—has the result that the first signal is additionally attenuated by a further 3.5 dB (see 15.5 dB), whereas the propagation loss in the second signal is only increased by 0.3 dB, i.e. a loss of 78.3 dB in the second signal is now contrasted with a loss of 75.5 dB in the first signal. The difference between the two propagation losses has now been advantageously reduced to 2.8 dB. Further optimizing in the direction of the least possible difference between the propagation losses is possible by further shifting the offset of the correlation peak.

Regarding the general operation of a code tracking loop, reference is made to the textbook “Spread Spectrum CDMA Systems for Wireless Communications” 1997, Artech House, Inc. Boston, London, pages 120 to 128, particularly page 124 to 126, chapter 3.2.3 Tau Dither Early-Late Noncoherent Tracking Loop with FIGS. 3.14 and 3.15. This discloses a method and a configuration for correlating a broadband radio-frequency signal modulated by the spread-spectrum transmission technique, using a Tau Dither Early-Late Code Tracking loop for code detection and code tracking.

We claim:

1. A method for a wireless information transmission, which comprises the steps of:
radiating a broadband radio-frequency signal between a base station and a multiplicity of subscribers, the subscribers being located at different distances from the base station;
coding the broadband radio-frequency signal received in the subscribers in accordance with a code division multiple access method according to information to be transmitted resulting in a coded broadband radio-frequency signal;
modulating the coded broadband radio-frequency signal resulting in a modulated broadband radio-frequency signal;
reflecting back the modulated broadband radio-frequency signal to the base station resulting in response signals received in the base station; and
effecting a signal correlation and demodulation of the response signals received in the base station, during the signal correlation, a time offset of a correlation peak is achieved and a time of the time offset of the correlation peak is calculated in such a manner that the response signals received from the subscribers disposed at a shorter distance to the base station are more attenuated than the response signals of the subscribers disposed at a greater distance from the base station, resulting in automatic compensation for different propagation losses between the subscribers located at the different distances from the base station.

2. The method according to claim 1, which comprises adapting a chipping rate of the broadband radio-frequency signal emitted by the base station to the different distances between the subscribers and the base station.

3. The method according to claim 1, which comprises generating the broadband radio-frequency signal in accordance with a direct sequence spread spectrum method.

4. The method according to claim 1, which comprises adapting a chipping rate of the broadband radio-frequency signal emitted by the base station to the propagation loses between the subscribers and the base station.

5. A configuration for wireless information transmission, comprising:
a base station radiating a broadband radio-frequency signal and having a transmitting device, a modulator/coder connected to said transmitting device, a receiving device and a demodulator/decoder with a correlator connected to said receiving device; and
a multiplicity of subscribers located at different distances from said base station, each of said subscribers having a modulation device and an antenna/backscattering device for receiving the broadband radio-frequency signal and for reflecting a response signal, coded in accordance with a code division multiple access method and modulated by said modulation device in accordance with information to be transmitted, said modulation device connected to said antenna/backscattering device, said correlator of said base station performing automatic compensation for different propagation losses between said subscribers located at different distances from said base station by linking a correlation function and a propagation loss to one another in an inverse relationship.

6. The configuration according to claim 5, wherein said base station generates the broadband radio-frequency signal in accordance with a direct sequence spread spectrum method.

7. An information system for a machine having at least one of a multiplicity of sensors and a multiplicity of actuators, comprising:
a base station radiating a broadband radio-frequency signal and having a transmitting device, a modulator/coder connected to said transmitting device, a receiving device and a demodulator/decoder with a correlator connected to said receiving device; and
a multiplicity of subscribers located at different distances from said base station, each of said subscribers having a modulation device and an antenna/backscattering device for receiving the broadband radio-frequency signal and for reflecting a response signal, coded in accordance with a code division multiple access method and modulated by said modulation device in accordance with information to be transmitted, said modulation device connected to said antenna/backscattering device, said correlator of said base station performing automatic compensation for different propagation losses between said subscribers located at different distances from said base station by linking a correlation function and a propagation loss to one another in an inverse relationship.

8. The information system according to claim 7, wherein the sensors are proximity sensors.

9. The information system according to claim 7, wherein said base station generates the broadband radio-frequency signal in accordance with a direct sequence spread spectrum method.

10. The information system according to claim 7, wherein the machine is an automatic production machine.
